(19) United States
(12) Patent Application Publication
(10) Pub. No.: US 2010/0147469 A1
(43) Pub. Date: Jun. 17, 2010

(54) Window covering with shade panels having free lower edges

(75) Inventors: Fu-Lai Yu, San Hsia Town (TW); Chin-Tien Huang, San Hsia Town (TW); Shun-Chi Yu, San Hsia Town (TW)

Correspondence Address: Olson & Cepuritis, LTD., 20 NORTH WACKER DRIVE, 36TH FLOOR, CHICAGO, IL, 60606, US

(73) Assignee: Teh-Yor Co., Ltd.

(21) Appl. No.: 12/655,307

(22) Filed: Dec. 29, 2009

Related U.S. Application Data
(63) Continuation of application No. 11/099,249, filed on Apr. 5, 2005.

(51) Int. Cl. E06B 9/32; E06B 9/30

(52) U.S. Cl. 160/113; 160/168.1 R

(57) ABSTRACT

A window covering including a plurality of panels vertically suspended from a vertical securement member is provided. The plurality of panels is secured with the securement member about an upper longitudinal portion of the panels at spaced intervals along the securement member. The panels are freely suspended or dangled from the securement member such that a lower longitudinal portion of the panels is not connected with the securement member or the opening member. A weighted edge member may be included about the lower longitudinal portion of the panels. The window covering is opened by adjusting the opening member to rearwardly and vertically stack the plurality of panels.

### CROSS REFERENCE TO RELATED APPLICATIONS

This application is a continuation of application Ser. No. 11/099,249 filed Apr. 5, 2005, the disclosure of which is incorporated by reference.

### FIELD OF THE INVENTION

The present invention relates to the field of window coverings, and more particularly to window coverings including a plurality of panels that are freely suspended from a securement member and create a substantially planar appearance.

### BACKGROUND OF THE INVENTION

Decorative window coverings are popular items for providing privacy and blocking light. These window coverings take on various forms, such as Roman shades, Venetian blinds, vertical blinds, honeycomb shades, and the like. Several of these window coverings include a panel or plurality of panels that cover an opening, which are connected to an adjustment mechanism with one or more control members.

For example, one popular type of window covering is known as a Roman shade. This type of shade consists of a fabric material attached along its top edge to a head rail and is gathered at spaced intervals to provide a series of soft folds across the face of the fabric. Consequently, the typical Roman shade has a cascaded or softly pleated appearance. Such Roman shades are constructed so that when they are raised, they gather from the bottom in generally horizontal folds or pleats until the entire shade resides near the top of the window covering. In some versions, the top of the window covering may also be lowered. The shades are operated by pulling on control members, which are attached to the shade. The control members are usually secured to a bottom portion of the panel with adhesive, ultrasonic welding, sewing, tying or the like.

An alternative to the conventional Roman shade is disclosed in co-pending application Ser. No. 10/427,829 filed on May 1, 2003 issued as U.S. Pat. No. 6,932,138, which is incorporated herein by reference. Unlike the standard Roman shade, the Roman style shade disclosed in U.S. Pat. No. 6,932,138 enables the opening of the individual rows to create gaps in the face of the shade without requiring the entire shade to be raised.

Another common type of window covering is a Venetian blind. Venetian blinds are typically constructed of a plurality of slats that are supported by a pair of ladders, which are controlled by an adjustment mechanism in a head rail. The ladder typically includes a pair of parallel cords suspended from the head rail and connected to a bottom rail. A number of rungs span across the parallel cords and support the slats. An alternative to the conventional Venetian blind is disclosed in co-pending application Ser. No. 10/413,200, which was issued as U.S. Pat. No. 6,792,996 and is incorporated herein by reference, which utilizes non-ladder control members and has a configuration that allows the slats to conceal the control members and holes for the control cords when the slats are closed.

While Roman shades and Venetian blinds are aesthetically pleasing, a window covering with a linear or generally flat appearance that maintains its general appearance whether opened, closed or partially opened may be desired in some instances. The present invention provides a suitable window covering.

### SUMMARY OF THE INVENTION

The present invention provides a novel and improved window covering. The window covering includes a head rail that has a control mechanism, such as a cord lock, adapted to control raising and lowering of an opening member suspended from the head rail. A securement member, such as a cord, is also suspended from the head rail. A plurality of panels is secured with the securement member about an upper longitudinal portion of the panels. Each of the panels is secured with the securement member at substantially evenly spaced intervals. The panels are freely suspended such that a lower longitudinal portion of the panels is not connected with the securement member or the opening member so the panels hang vertically from the securement member. A weighted edge member may be included about the lower longitudinal portion of the panels.

Preferably, the plurality of panels are in an overlapping relationship with one another. In particular, the lower longitudinal portion of a panel overlaps with the upper longitudinal portion of the lower adjacent panel. As such, when the window covering is closed, there are no gaps between panels that would permit light to enter a room. Similarly, the opening and securement members are concealed by the overlapping panels when the window covering is in the closed position.

In some embodiments, a lowermost panel of the plurality of panels is also secured with the opening member about an upper longitudinal portion. The other panels position between the headrail and the lowermost panel are unconnected to the opening member. In other words, adjustment of the opening member only directly moves the lowermost panel. In some embodiments, additional opening members may be included and secured to a different panel. One example of such a configuration is discussed in further detail below.

To open the window covering, a user pulls or retracts the opening member, which draws upwards the lowermost panel while the remaining panels remain in a resting position. The lowermost panel slides upwards substantially parallel to and behind an upper adjacent panel. By continuing to retract the opening member, the upper longitudinal portion of the lowermost panel contacts the upper longitudinal portion of the upper adjacent panel. The lowermost panel is therefore no longer able to move in an upwards direction independent of the upper adjacent panel. As such, the lowermost panel and the upper adjacent panel are moved together behind the next upper adjacent panel. Each of the panels are rearwardly stacked in this manner as the opening member is retracted.

By rearwardly stacking the panels in this manner, the vertical and straight profile of individual panels is maintained as the window covering is opened. Accordingly, the aesthetic appearance of the window covering is largely kept constant whether the window covering is in a fully closed, partially opened or fully opened position.

An alternative embodiment of the present invention affords the capability of lowering the various panels as a different manner of opening the window covering. The window covering, as in the previous embodiment, includes rows of panels. A valance panel is secured directly to the head rail. A plurality of additional panels are suspended by control members from the head rail. The upper longitudinal portion of an uppermost panel is secured with a first opening member such that the uppermost panel is operatively connected to the head rail. A securement member is also secured with the upper longitudinal portion of the uppermost panel, and is also secured with the upper longitudinal portion of the other panels, except the valance panel. The securement member is not connected with the head rail.

A lowermost panel of the plurality of panels is also secured with a second opening member about an upper longitudinal portion thereof. The second opening member is suspended from the head rail and is controllably adjusted with a control mechanism. The other panels are not secured with the second opening member.

To open the window covering, a user may pull or retract the second opening member, which draws upwards the lowermost panel while the remaining panels remain in a resting position in the manner previously described. The window covering may also be opened by lowering the uppermost panel by lowering the first opening member. In either event, the position lowermost panel relative to the upper adjacent panels is adjusted such that the lowermost panel is positioned behind and substantially parallel with the upper adjacent panel.

For example, when raising the second opening member, the lowermost panel slides upwards substantially parallel to and behind an upper adjacent panel. By continuing to retract the opening member, the upper longitudinal portion of the lowermost panel contacts the upper longitudinal portion of the upper adjacent panel. The lowermost panel is therefore no longer able to move upwardly independent of the upper adjacent panel. As such, the lowermost panel and the upper adjacent panel are moved together behind the next upper adjacent panel. The panels are rearwardly stacked in this manner as the opening member is retracted. By contrast, as the first opening member is lowered, the plurality of panels above the lowermost panel slide down such that the upper adjacent panel to the lowermost panel slides in front of and substantially parallel to the lowermost panel. Because the panels overlap, subsequent panels are stacked in front of previously stacked panels. The first and second opening members may operated in any combination. For example, if the second opening member lowers all the panels into a stack, the first opening member can raise the entire stack.

One preferred feature of the window covering of the present invention includes the manner in which the panels are secured with the securement member and opening member. Each of the panels may be secured with the securement member and opening member with fastener modules. In one embodiment, the fastener module includes a clip member securable to the upper longitudinal portion of a panel and a buckle member comprising a housing and an engagement member, the buckle member suitable for detachable and selectable securement to the securement member. In a preferred embodiment, the securement member is a cord that includes a plurality of spaced loops, whereby the upper longitudinal portion of each panel is operatively secured with a loop. A particularly suitable fastener module is described in co-pending application Ser. No. 10/970,428 entitled Fastener Module for a Window Covering and Method, which was filed on Oct. 21, 2004, and issued as U.S. Pat. No. 7,516,769, which is hereby incorporated by reference.

Another preferred feature of the window covering of the present invention is an arrangement of groups of panels wherein each group of panels includes a top panel secured to the securement member and a bottom panel secured to an opening member. By retracting the opening member, the bottom panel of each group of panels is drawn behind other panels in the groups, and thereby stacking the panels as they are raised. Alternatively, the top panel of each group may be secured to the opening member and be lowered relative to the bottom panel that is secured to the securement member. In these embodiments, a second opening member is preferably included that is secured to either the lowermost top panel or a bottom member to raise the entire window covering.

### BRIEF DESCRIPTION OF THE DRAWINGS

In the drawings:

FIG. 1 is a perspective front view of a preferred embodiment of the window covering of the present invention in a closed position;

FIG. 2 is an elevated right side view of the window covering of FIG. 1;

FIG. 3 is an elevated left side view of the window covering of FIG. 1;

FIG. 4 is a perspective front view of the window covering of FIG. 1 in a partially open position;

FIG. 5 is a perspective front view of the window covering of FIG. 1 in a fully open position;

FIG. 6 is an elevated right side view of the window covering of FIG. 5 in a fully open position;

FIG. 7 is an elevated left side view of the window covering of FIG. 5 in a fully open position;

FIG. 8 is an enlarged perspective view of a fastener module suitable for use with the present invention;

FIG. 9 is a front perspective view of an alternate embodiment of a window covering according to the present invention;

FIG. 10 is a rear perspective view of the window covering of FIG. 9;

FIG. 11 is an enlarged perspective view of a portion of FIG. 10;

FIG. 12 is a rear perspective view of the window covering of FIG. 9 in a partially open position;

FIG. 13 is a front perspective view of the window covering of FIG. 9 in a fully open position;

FIG. 14 is a rear perspective view of the window covering of FIG. 13 in an alternative partially open position;

FIG. 15 is a front perspective view of another embodiment of a window covering in the closed position according to the present invention;

FIG. 16 is a front perspective view of the embodiment of FIG. 15 with the window covering in a partially open position;

FIG. 17 is a rear perspective view of the embodiment of FIG. 15 with the window covering in a partially open position;

FIG. 18 is an enlarged portion of FIG. 17; and

FIG. 19 is a front perspective view of yet another embodiment of a window covering in a partially open position according to the present invention.

### DESCRIPTION OF THE PREFERRED EMBODIMENTS

The invention disclosed herein is, of course, susceptible of embodiment in many different forms. Shown in the drawings and described hereinbelow in detail are preferred embodiments of the invention. It is understood, however, that the present disclosure is an exemplification of the principles of the invention and does not limit the invention to the illustrated embodiments. For ease of description, the window covering embodying the present invention is described in its usual assembled position as shown in the accompanying drawings, and terms such as upper, lower, horizontal, longitudinal, etc., may be used herein with reference to this usual position.

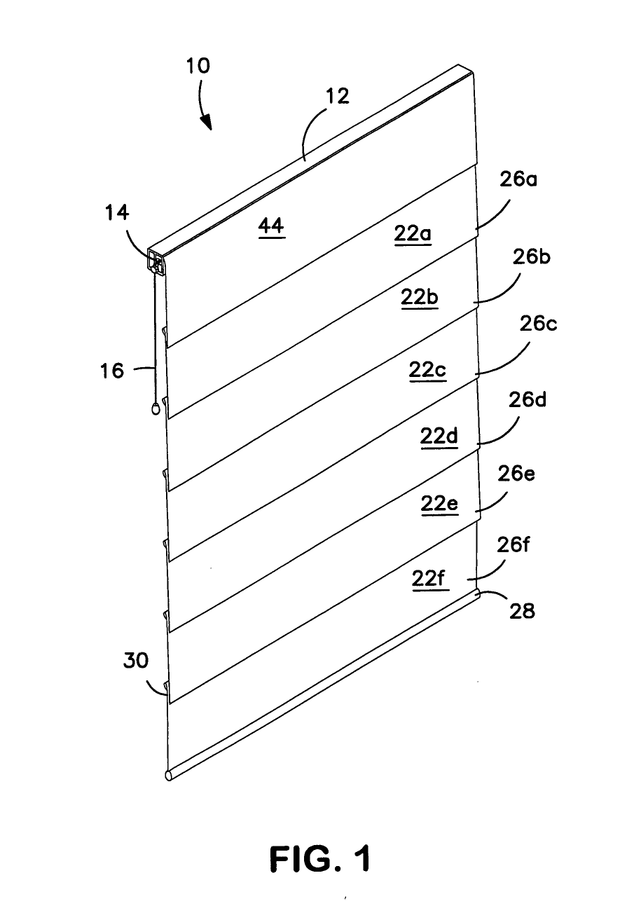

A window covering according to one embodiment of the present invention is described with reference to FIGS. 1-3. Window covering 10 includes a head rail 12 including a control mechanism, such as cord lock 14, adapted to control raising and lowering of an opening member, such as opening cord 16, which is suspended from the head rail 12. A securement member, such as securement cord 18, is also suspended from the head rail 12. The securement cord 18 and the opening cord 16 pass down the back of the window covering 10. Securement cord 18 preferably includes a plurality of spaced loops 20. A plurality of intermediate panels 22a-e and a lowermost panel 22f are secured with the securement cord 18 about an upper longitudinal portion 24 of the panels 22 such as at some of the spaced loops 20. The panels may be made of a woven or nonwoven fabric, paper, laminate, film, or the like. The panels are freely suspended from the securement member 18 such that a lower longitudinal portion 26a-f of the panels 22a-f are not connected with the securement member 18 or the opening member 16. The lowermost panel 22f of the plurality of panels is secured with the opening member 16 about an upper longitudinal portion 30 of the lowermost panel 22f. A bottom rail 28 may also be secured with lowermost panel 22f. The intermediate panels 22a-e are not secured with the opening member. A valance panel 44 is also provided. This valance panel 44, which has the same basic construction as panels 22 and includes a stiffening strip 45, is clipped directly to the head rail 12, and is not otherwise connected with the panels 22a-f.

The panels 22a-f overlap one another such that no light is able to pass through the window covering 10 when in the closed position. Also, the overlapped panels 22a-f conceal the opening member 16 and the securement member 18 extending behind the panels when viewed from the face of the window covering 10.

Each of the intermediate panels 22a-e also preferably includes a weighted edge member, such as stiffening strips 32a-e, positioned about the lower longitudinal portion 26a-e. Bottom rail 28 acts as the weighted edge member for the lowermost panel 22f. The stiffening strips 32a-e and bottom rail 28 are suitable for exerting gravitational force on the panels 22a-f such that any bias in the material, such as from weaving or coatings, is overcome and the panels 22a-f hang straight down. This weighted edge members may also take the form of a rod, rolled material, clips, or the like.

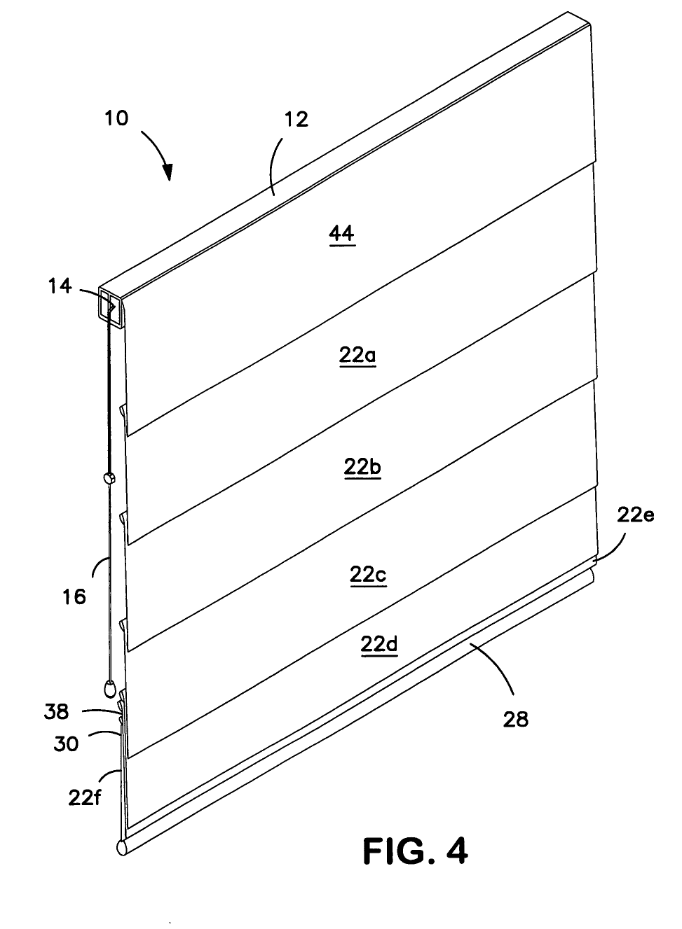

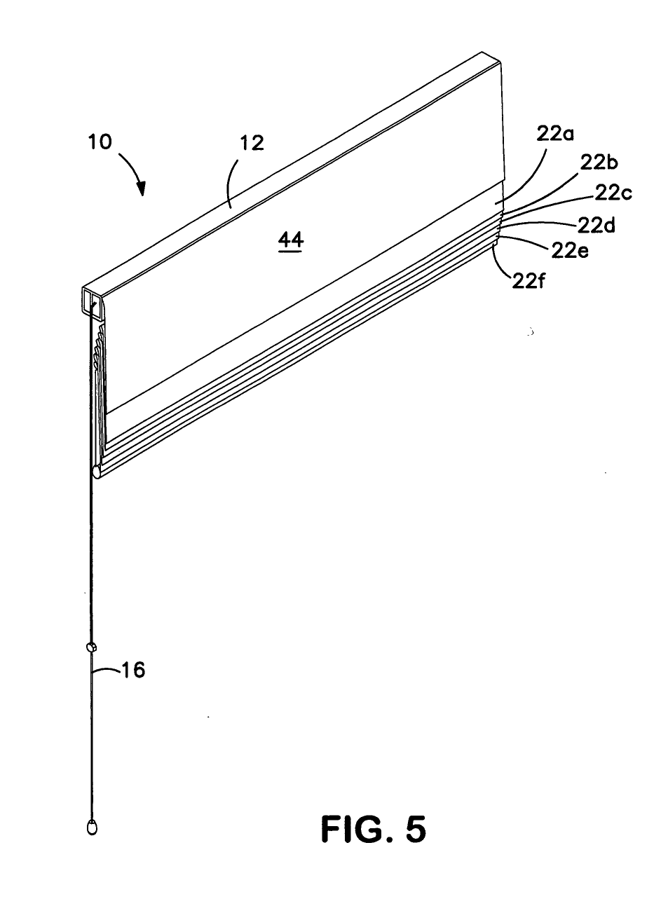

To open the window covering 10, a user pulls or retracts the opening member 16, which draws upwards the lowermost panel 28 while the remaining panels remain in a resting position. Referring to FIG. 4, the lowermost panel 22f slides upwards substantially parallel to and behind an upper adjacent panel 22e. By continuing to retract the opening member 16, the upper longitudinal portion 30 of the lowermost panel 22f contacts the upper longitudinal portion 38 of the upper adjacent panel 22e. The lowermost panel 22f is therefore no longer able to move upwardly relative to the upper adjacent panel 22e. As the opening member 16 is retracted further, the lowermost panel 22f and the upper adjacent panel 22e are moved together behind the next upper adjacent panel 22d. The panels 22a-f are rearwardly stacked in this manner as the opening member 16 is retracted until the panels 22a-f are rearwardly stacked as shown in FIG. 5.

As is shown, the rearward stacking of the panels provides a window covering 10 wherein the vertical and straight profile of the panels 22a-f is maintained as the window covering 10 is opened. Accordingly, the aesthetic appearance of the window covering 10 is largely kept consistent whether the window covering is in a fully closed (FIG. 1), partially opened (FIG. 4) or fully opened position (FIG. 5).

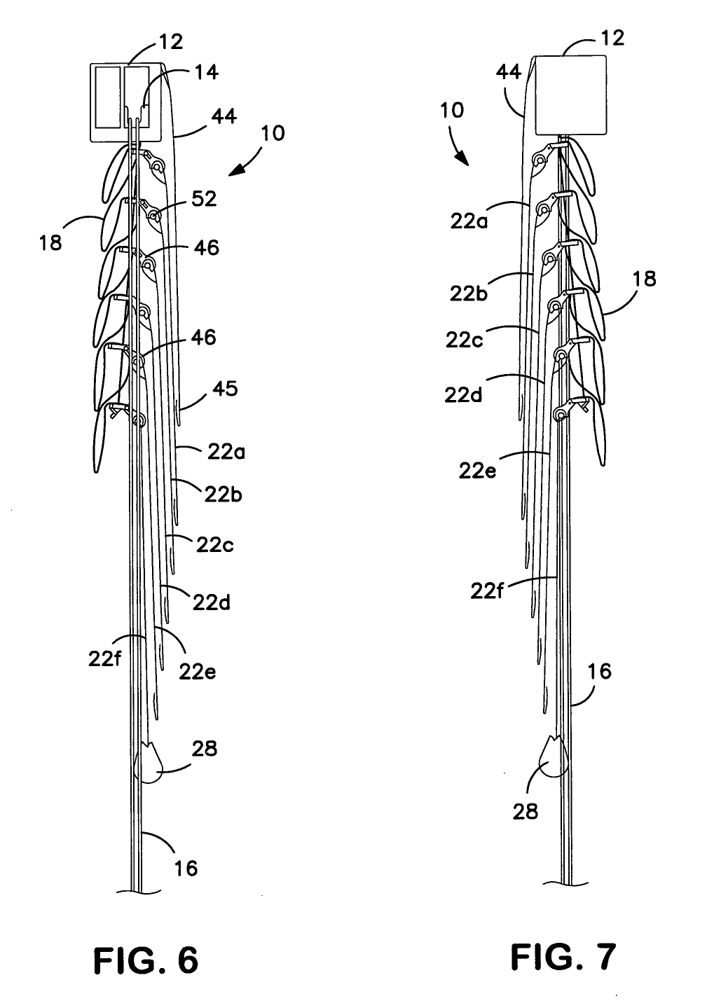

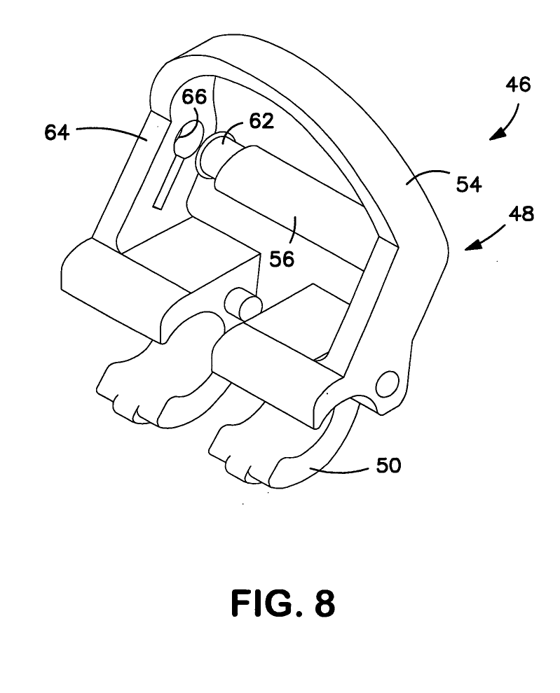

Referring to FIGS. 6 and 7, as the panels 22 are stacked, the securement cord 18 is folded or gathered behind the face 42 of the window covering 10. The opening member 16 holds the panels 22a-f in position by locking the control mechanism, such as cord lock 14. Since the overlapping relationship of the panels 22a-f is maintained in the closed, partially opened, and fully opened positions, the securement cord 18 is not seen from the front of the window covering.

Panels 22a-f are preferably detachably secured with the securement cord 18 with fastener modules 46. An exemplar of a suitable fastener module 46 is shown in FIG. 8. Fastener module 46 includes a buckle 48 and a clip 50, and is preferably made of a resilient material, such as a thermoplastic resin, lightweight metal, or the like. The clip 50 is securable to an anchor member, such as dowel 52 associated with the panel (FIG. 6) by way of frictional engagement or by a mechanical force applied by the clip 50, such as exerted by the resilient properties of the material making up the clip 50. Buckle 48 includes a housing 54 and an engagement member, such as transverse rod 56. Transverse rod 56 includes a first end, which is secured to or integral with the housing 54, and a second end 62, which is engageable with tab member 64 by urging second end 62 through hole 66. Where detachable fastener modules are used, it is also possible to have one or more panels entirely detachable.

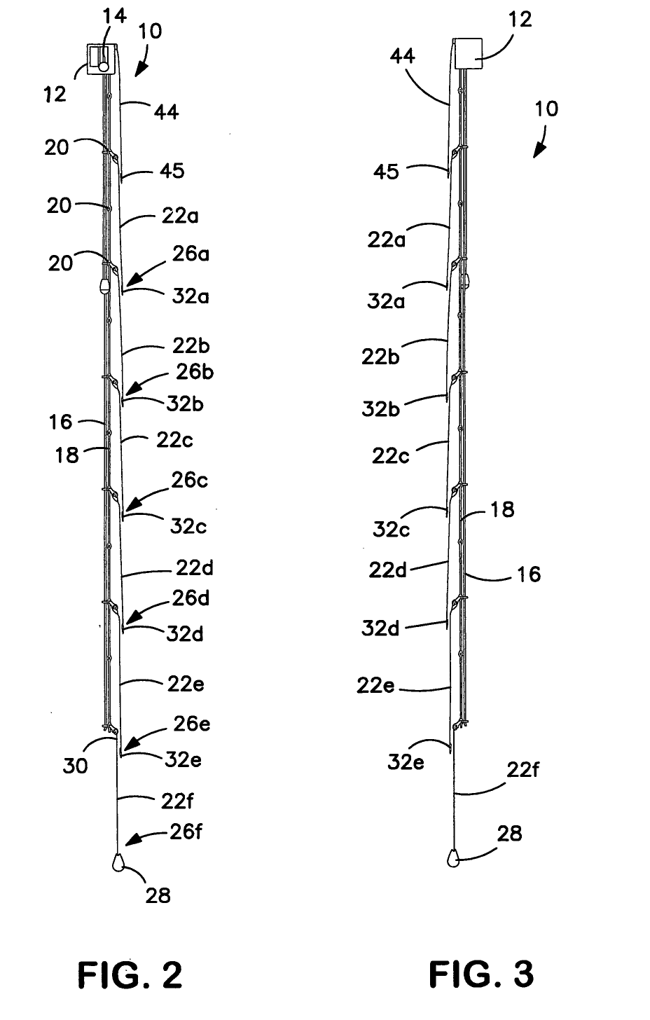

The securement cord 18 is engaged with fastener module 46 by way of transverse rod 56, which is passed through a loop in the panel, such a loop 20 (FIG. 2) defined by securement cord 18. Opening cord 16 is passed through housing 54 of fastener module 46, but is not secured thereto. As such, as opening cord 16 is retracted or extended, is passes through housing 54 and moves freely relative thereto such that the fastener module 46 acts as a cord guide for opening cord 16.

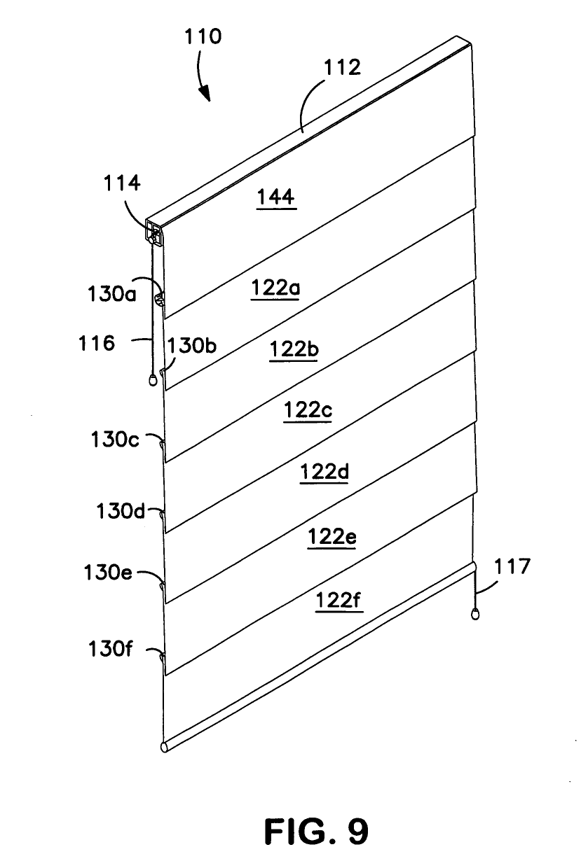

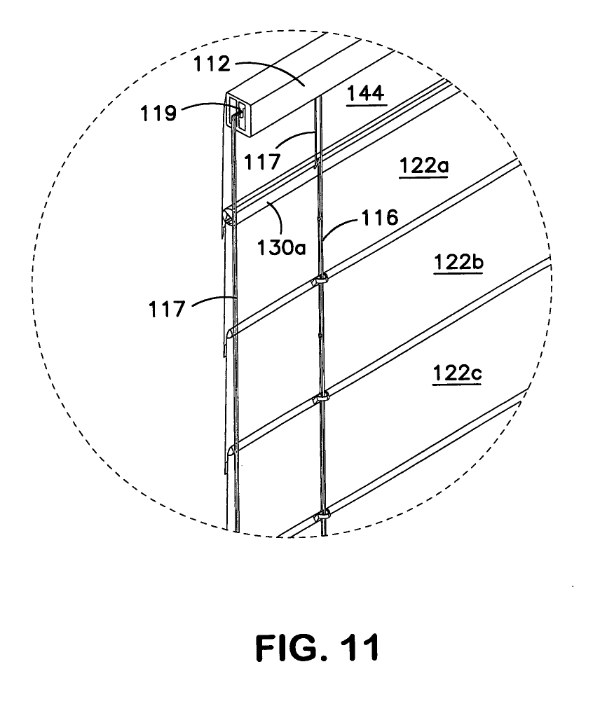

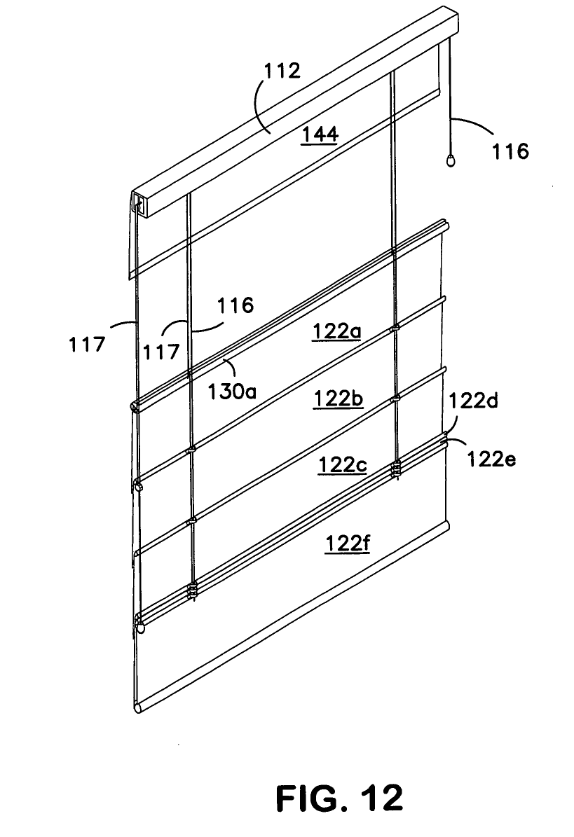

An alternative embodiment of the present invention is described with reference to FIGS. 9-14. Window covering 110 includes a head rail 112, a valance panel 144, and plurality of panels 122a-f. The valance panel 144 and the other panels 122a-f overlap one another such that a gap free face is provided. The appearance of the alternative embodiment of the window covering 110 in the closed position as shown in FIG. 9 is substantially the same as the previous embodiment. However, the operation of window covering 110 is somewhat different in that rather than only opening the window covering 110 by raising panels, the window covering 110 may be opened by lowering panels as well.

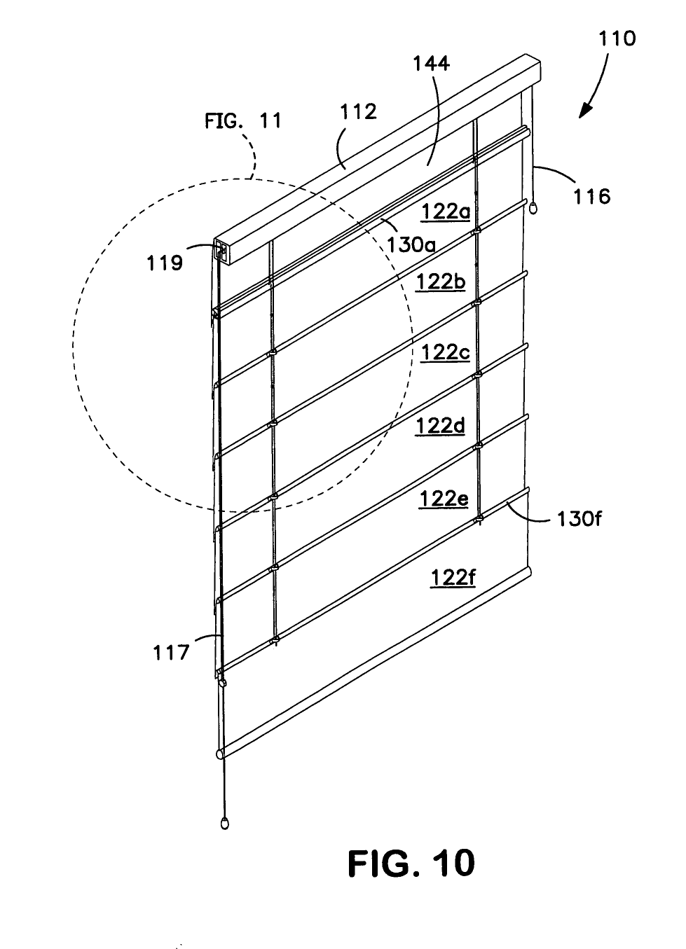

Referring to FIGS. 9-11, additional features of window covering 110 are shown. The plurality of panels 122a-f are suspended by control members from the head rail 112. The uppermost panel 122a, which defines an uppermost portion 130a is secured with a first opening member, such as first opening cord 117, which is adjustably controlled by cord lock 119 (FIG. 10). A securement member, such as securement cord 118 secures the uppermost portion 130a of the uppermost panel 122a with the uppermost portions 130b-f of the other panels 122b-f.

A lowermost panel 122f of the plurality of panels is also secured with a second opening member, such as second opening cord 116, about an upper longitudinal portion thereof 130f. The second opening cord 116 is suspended from the head rail 112 and is controllably adjusted with a control mechanism, such as a cord lock 114. The other panels 122a-e are not secured with the second opening cord 116.

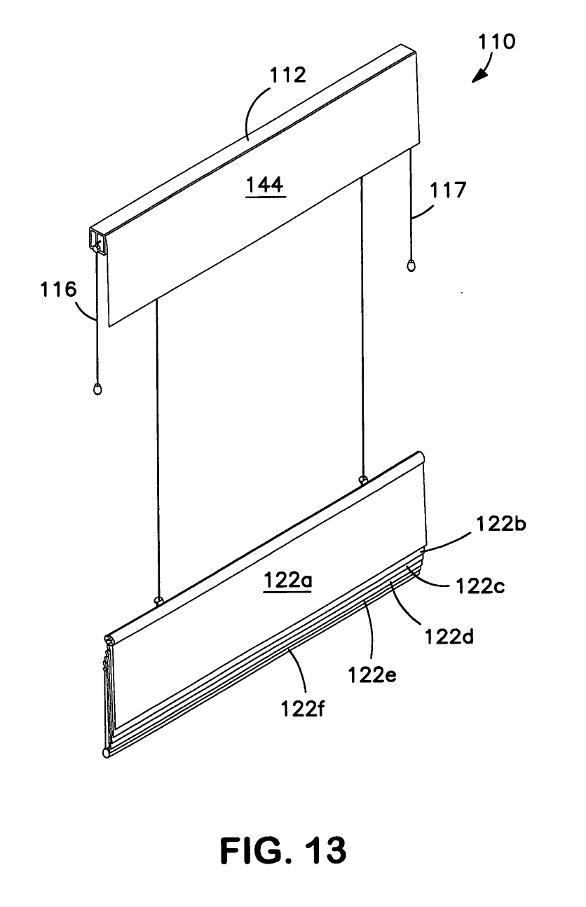

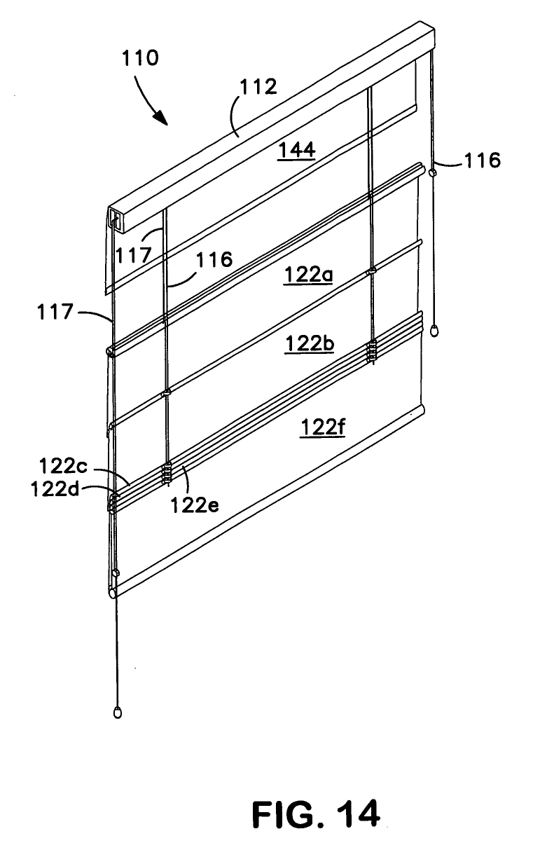

Opening window covering 110 may be accomplished in a number of different manners. One way is to pull on second opening cord 116 to raise lowermost panel 122f, such as described in the embodiment of FIGS. 1-7. Alternatively, window covering 110 may also be opened by lowering the uppermost panel 122a by lowering the first opening cord 117. Referring to FIG. 12, as the first opening cord 117 is lowered, intermediate panels 122a-e are lowered relative to the lowermost panel 122f such that the panels, such as panels 122e and 122d are stacked with the lowermost panel 122f. When the first opening cord 117 is fully lowered, the panels 122a-f are stacked at the bottom of window covering 110 such as shown in FIG. 13.

The first opening cord 117 and the second opening cord 116 may also be operated in conjunction with one another. For example, as is shown in FIG. 14, the first opening cord 117 has been partially lowered such that panel 122e is stacked with the lowermost panel 122f. Second opening cord 116 has also been raised such that lowermost panel 122f and panel 122e are stacked with panels 122c and 122d.

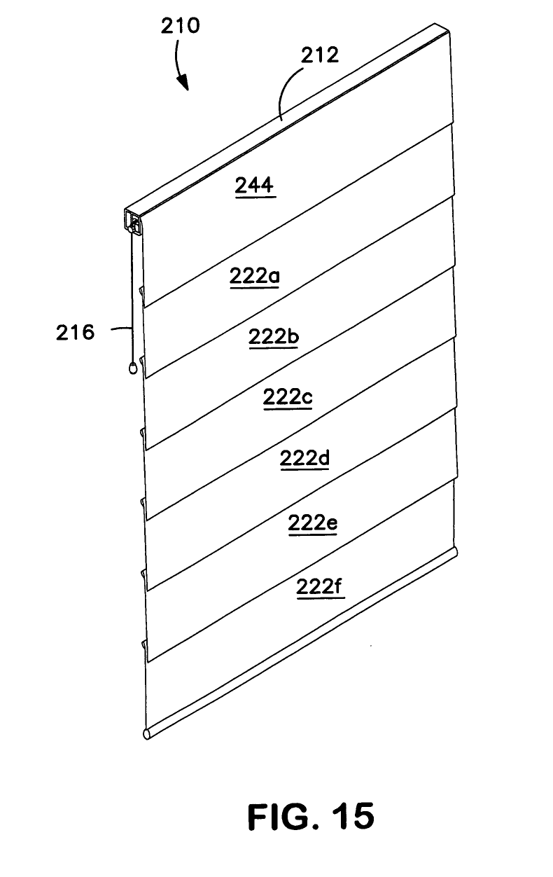

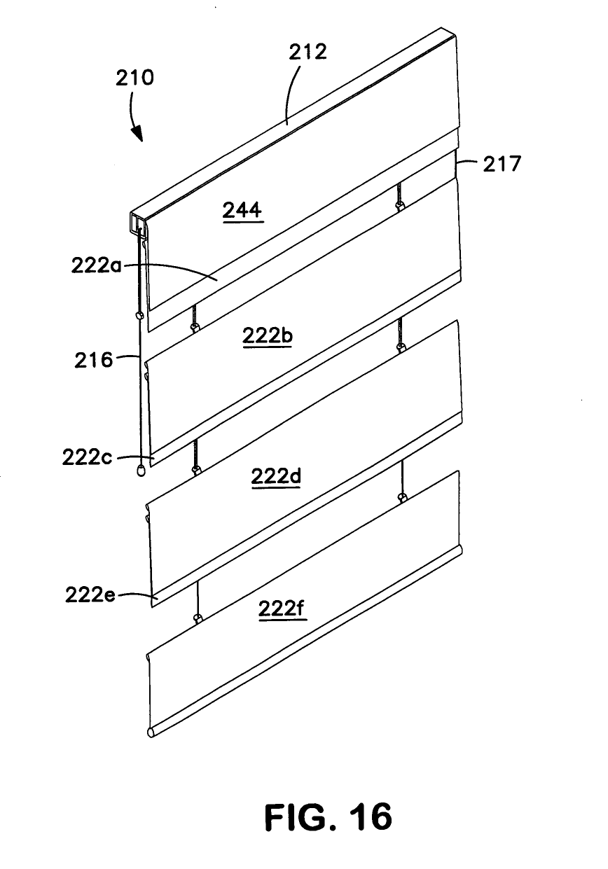

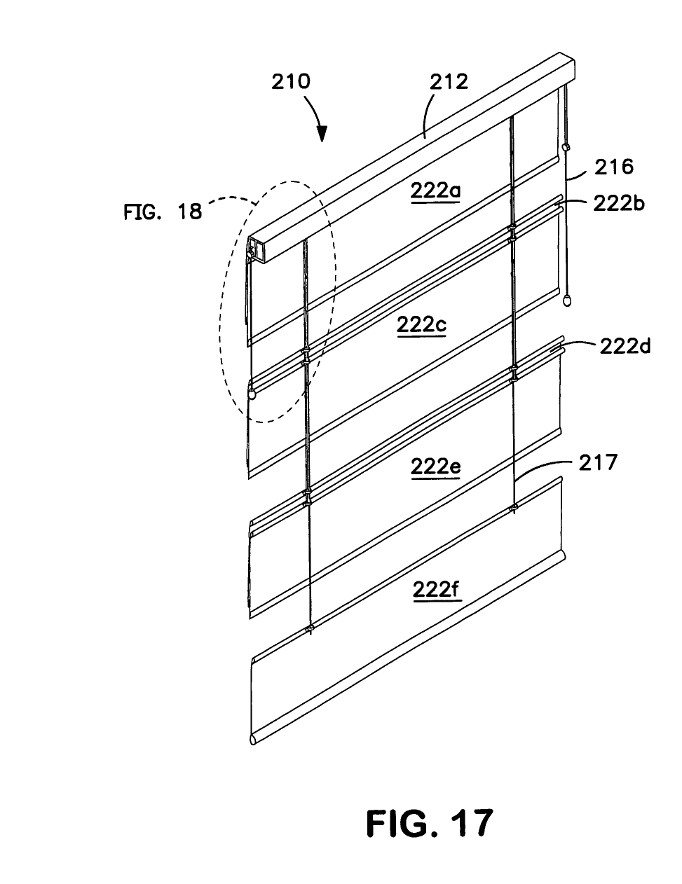

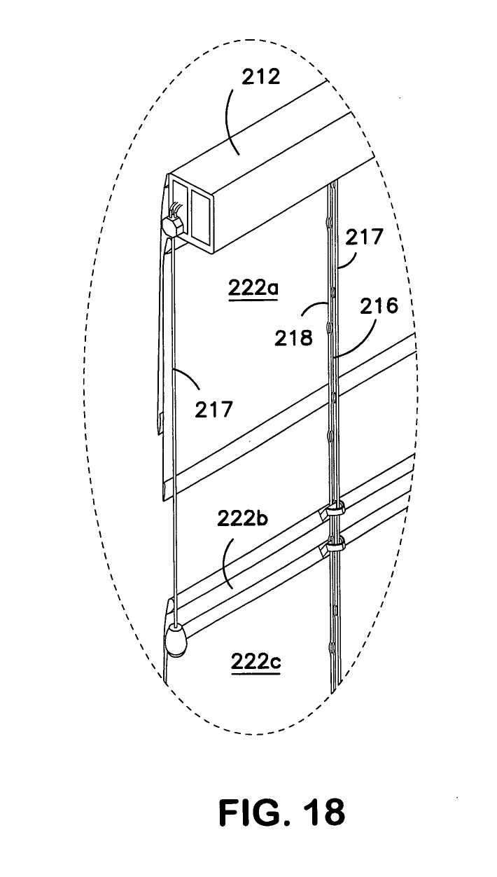

Yet another embodiment of the present invention is shown with reference to FIGS. 15-18. Similar to the previous embodiment, as shown in FIG. 15, the window covering 210 includes a head rail 212, an opening member 216, a valance panel 244 and a plurality of panels 222a-f. However, referring to FIGS. 16 and 17, the panels are grouped into two sets. In particular, panels 222a, 222c, and 222e are one set and panels 222b, 222d, and 222f are the other set. This variation provided the optional feature of sliding a first set of panels, such as panels 222b, 222d, and 222f relative to a second set, such as panels 222a, 222c, and 222e. A first opening cord 216 is secured to the upper longitudinal portions of panels 222a, 222c, and 222e. Panels 222b, 222d, and 222f are secured to securement cord 218. Panel 222f is also secured to a second opening cord 217.

By pulling on first opening cord 216, panels 222a, 222c, and 222e are raised and slid behind valance panel 244 and panels 222b and 222d, respectively. Retracting second opening cord 217 causes lowermost panel 222f to raise and open the entire window covering 210 such as discussed above.

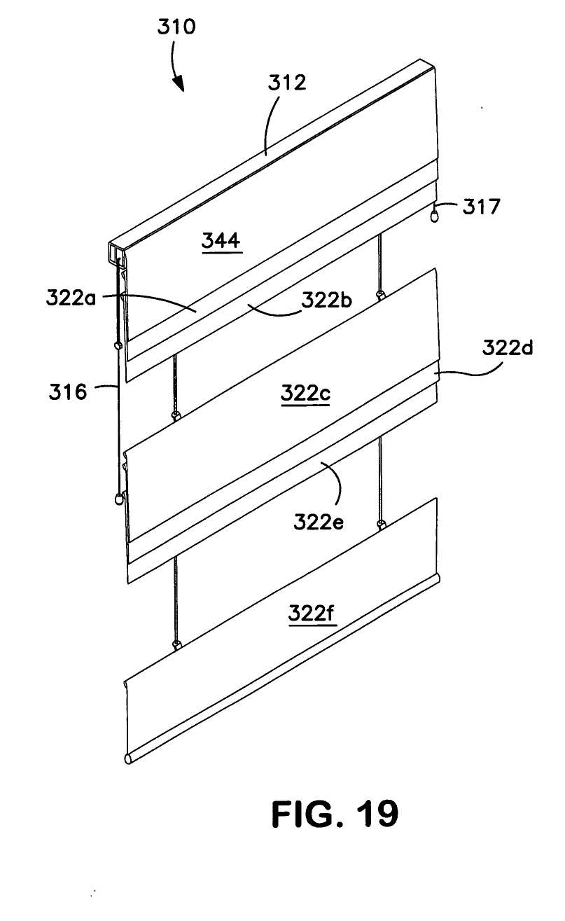

Yet another variation of the present invention is shown in FIG. 19. In this embodiment, the panels 322a-e of window covering 310 are grouped into two groups. A first group consists of panels 322a and 322b and the second group consists of panels 322c-e. The upper longitudinal portion of panels 322e and 322b are secured with a first opening cord 316. Panels 322a, 322c and 322d are secured with a securement cord 318. Lowermost panel 322f is secured to a second opening cord 317. In this embodiment, as first opening cord 316 is raised, panels 322e and 322b are raised and slid behind panels 322d and 322a, respectively. As the first opening cord 316 is further raised, panels 322a and 322b are stacked behind valance panel 344, and panels 322d and 322e are stacked with panel 322c. Each of panels 322a-f may be raised by raising the second opening cord 317.

Alternatively, the upper longitudinal portion of the panel 322b can be connected to a first opening cord while the upper longitudinal portion of the panel 322e is connected to a second opening cord, and the upper longitudinal portion of the lowermost panel 322f is connected to a third opening cord. The panel 322b can be thereby opened independently from the panels 322e and 322d.

In the embodiments described, the panels are described as being uniform in size. However, it is also possible that the panels are of incrementally narrower widths such that the panels when stacked complete conceal the stacked panels.

The foregoing description and the accompanying drawings are illustrative of the present invention. Still other variations and arrangements of parts are possible without departing from the spirit and scope of this invention.

We claim:

1. A window covering having an open condition and a closed condition, the window covering comprising:
a head rail including at least one control mechanism adapted to control vertical adjustment of at least one opening member;
a securement member;
a first group of panels including a first top panel and a first bottom panel, the first top panel being secured with the securement member about an upper longitudinal edge portion and detached from the opening member, the first bottom panel being secured about an upper longitudinal edge portion with the at least one opening member, such that a lower longitudinal edge portion of each of the first group of panels is disconnected from the securement member and the at least one opening member;
a second group of panels including a second top panel and a second bottom panel, the second top panel being secured with the securement member about an upper longitudinal edge portion and detached from the opening member, the second bottom panel being secured about an upper longitudinal edge portion with the at least one opening member, such that a lower longitudinal edge portion of each of the second group of panels is disconnected from the securement member and the at least one opening member; and
the control mechanism enabling vertical adjustment of the opening member such that the first bottom panel and the second bottom panel are moved substantially parallel to and behind the first top panel and the second top panel, respectively.

2. The window covering of claim 1, wherein the plurality of panels are in an overlapping relationship.

3. The window covering of claim 1, wherein the panels are replaceably detachable from the securement member.

4. The window covering of claim 1, further including a second opening member, the second opening member being secured to an upper longitudinal edge portion of an upper panel and adapted to lower the upper panel relative to the head rail.

5. The window covering of claim 1, wherein the lower longitudinal edge portion of at least one of the intermediate panels includes a weighted edge member.

6. The window covering of claim 1, wherein the securement member is a securement cord and the opening member is an opening cord, and the securement cord and the opening cord each comprise a plurality of spaced loops.

7. The window covering of claim 1 further comprising a raising member having a first portion connected to the head rail and a second portion connected to the second group of panels, such that raising of the raising member causes the second group of panels to slide substantially parallel to and behind the first group of panels.

8. The window covering of claim 1, wherein adjustment of the opening member causes the plurality of panels to be rearwardly stacked.

9. A window covering comprising:
a securement cord;
at least one opening cord adapted to be retracted and extended;
a plurality of freely suspended intermediate panels, each of the intermediate panels being separate from the other intermediate panels, the plurality of intermediate panels comprising at least two groups of panels, each group of panels comprising a top panel and a bottom panel, the top panel being secured about an upper longitudinal edge portion to the securement member and being detached from the opening member, the bottom panel being secured about an upper longitudinal edge portion to the opening member; and
the opening cord adapted to be adjusted to move the window covering from the closed position to the open position wherein vertical adjustment of the opening cord rearwardly stacks each group of panels such that the respective bottom panel is moved parallel to and behind the top panel.

10. The window covering of claim 9, wherein the intermediate panels are detachably secured with the securement cord with fastener modules.

11. The window covering of claim 9, wherein the lower longitudinal edge portion of the intermediate panels includes weighted edge member.

12. The window covering of claim 9, further including a second opening cord secured to an upper longitudinal edge portion of an uppermost panel, the second opening cord adapted to be adjusted to move the window covering from the closed position to the open position.

13. The window covering of claim 9, wherein the intermediate panels are substantially flat and unfolded.

14. A window covering comprising:
a head rail including at least one control mechanism adapted to control vertical adjustment of at least one opening member;
a securement member suspended from the head rail;
a plurality of intermediate panels secured to the securement member and comprising a group of first panels and a group of second panels, each of the intermediate panels being separate from other panels for defining a face of the window covering;
each of the first panels being secured at spaced intervals with the securement member about an upper longitudinal edge portion thereof, the first panels being freely suspended such that the first panels maintain a substantially planar shape, and such that a lower longitudinal edge portion of each of the first panels is disconnected from the securement member and the at least one opening member;
each of the second panels being secured at spaced intervals with the opening member about an upper longitudinal edge portion thereof, the second panels being freely suspended such that the second panels maintain a substantially planar shape, and such that a lower longitudinal edge portion of each of the second panels is disconnected from the securement member and the at least one opening member; and
wherein the opening member is operable to cause each of the second panels to move along the face of the window covering toward a corresponding one of the first panels remaining stationary, such that each of the second panels and the corresponding one of the first panels substantially overlap parallel with each other for forming one or more gaps through the face of the window covering.

15. The window covering of claim 14, wherein each of the intermediate panels is detachably secured to the securement member.

16. The window covering of claim 15, wherein the intermediate panels are detachably secured with the securement member with fastener modules.

17. The window covering of claim 14 further comprising a second opening member operatively connected to the head rail and a second opening member control mechanism, wherein retracting of the second opening member raises a lowermost panel member and rearwardly stacks the intermediate panels.

18. The window covering of claim 14 wherein a bottom member is secured to the second opening member, and retraction of the second opening member rearwardly stacks the intermediate panels.

19. The window covering of claim 14, wherein the securement member is a securement cord and the opening member is an opening cord.

20. The window covering of claim 14, wherein each of the first panels is adjacent to a corresponding one of the second panels.
